(19) United States
(12) Patent Application Publication
(10) Pub. No.: US 2026/0275117 A1
(43) Pub. Date: Sep. 17, 2026

(54) COMPOSITIONS FOR HIGH SOLAR REFLECTIVITY AND METHODS OF PRODUCTION THEREOF

(71) Applicant: The Regents of the University of California, Oakland, CA (US)

(72) Inventors: Xiao Nie, Irvine, CA (US); Jaeho Lee, Irvine, CA (US)

(21) Appl. No.: 19/168,518

(22) PCT Filed: Apr. 12, 2024
(86) PCT No.: PCT/US2024/024435

§ 371 Date: Sep. 24, 2025

Related U.S. Application Data
(60) Provisional application No. 63/495,991, filed on Apr. 13, 2023.

(51) Int. Cl. C09D 5/33; C09D 1/00; C09D 7/40; C09D 7/61

(52) U.S. Cl. CPC C09D 5/004; C09D 1/00; C09D 7/61; C09D 7/70

(57) ABSTRACT

Since theoretical studies point out that Y₂O₃ hollow microspheres are promising to develop a near-perfect solar reflector, the Inventors experimentally fabricate Y₂O₃ hollow microspheres using a carbon microspheres templated hydrothermal approach. By integrating Y₂O₃ hollow microspheres with KBr binder, the coating achieves a high solar reflectivity, comparable to or exceeding the state of the art materials reported in the literature and the materials commercially available in the market.

### CROSS-REFERENCE TO RELATED APPLICATIONS

This application claims benefit of U.S. Provisional Application No. 63/495,991 filed Apr. 13, 2023, the specification of which is incorporated herein in their entirety by reference.

### FIELD OF THE INVENTION

The present invention features compositions comprising a white coating based on yttrium oxide (Y₂O₃) hollow microspheres for high solar reflectivity that can be used for various thermal and optical applications as well as methods for production thereof.

### BACKGROUND OF THE INVENTION

Global energy consumption problems associated with rapid urbanization and population growth call for novel cooling technologies and innovative materials for use in urban environments. The annual cooling or air conditioning energy demand is forecasted to exceed ten quintillion joules by 2040, and the associated carbon emissions and air pollution may play a critical role in early death, linked to 6.5 million premature deaths worldwide. As a potential solution, passive cooling materials with high solar reflectivity have gained more attention. Solar reflectivity higher than 0.9 is usually needed to achieve effective radiative cooling under sunlight. Various forms of materials, such as multilayers, microspheres, nanoparticles, porous structures, and composites, have been developed to achieve significant cooling performance. Since the heat gain by solar absorption can be about ten times greater than the heat loss by thermal emission, minimizing solar absorption is critical. The reflectivity needs to be high across the ultraviolet, visible, and near-infrared wavelength ranges. Many achievements have been made to offer solar reflectivity above 0.9.

### BRIEF SUMMARY OF THE INVENTION

It is an objective of the present invention to provide compositions and methods that enable high solar reflectivity (e.g., a solar reflectivity greater than 0.9), as specified in the independent claims. Embodiments of the invention are given in the dependent claims. Embodiments of the present invention can be freely combined with each other if they are not mutually exclusive.

Theoretical studies by the Inventors indicated that materials with high refractive index and low extinction coefficient, such as Y₂O₃, hold significant potential for creating a near-perfect solar reflector when these materials are fabricated into hollow microspheres. Thus, described herein are methods for successfully synthesizing Y₂O₃ hollow microspheres through a carbon microsphere-templated hydrothermal technique and the subsequent fabrication of coatings using these microspheres. The microstructures of the Y₂O₃ hollow microspheres were analyzed via scanning electron microscopy (SEM) and energy dispersive spectroscopy (EDS). The solar reflectivity was also assessed using optical spectroscopy across ultraviolet, visible, and near-infrared spectra. A model predicting the influence of coating thickness on solar reflectivity was also established, alongside a comprehensive characterization of the thermal properties through infrared thermography.

In some embodiments, the present invention features a high solar reflectivity coating composition comprising metal oxide hollow microspheres. For example, the present invention may feature a high solar reflectivity coating composition comprising yttrium oxide (Y₂O₃) hollow microspheres. The aforementioned compositions may further comprise a binder (e.g., an inorganic binder). The present invention features a high solar reflectivity coating composition comprising metal oxide (e.g., Y₂O₃) hollow microspheres and an inorganic binder (e.g., KBr). In some embodiments, the hollow microspheres and the inorganic binder are in a solution (e.g., water). Additionally, the solution comprising the hollow microspheres and the inorganic binder may be deposited onto a substrate (e.g., a black substrate). The compositions described herein may have a thickness of about 0.2 mm to 2.5 mm, or about 0.2 mm to 1.5 mm, or about 0.2 mm to 0.5 mm, or about 0.5 mm to 2.5 mm, or about 0.5 mm to 1.5 mm, or about 1.5 mm to 2.5 mm. Furthermore, the solar reflectivity of the composition may be about 0.90 to 0.98.

In other embodiments, the present invention features a high solar reflectivity composition comprising metal oxide hollow microspheres. For example, the present invention may feature a high solar reflectivity composition comprising yttrium oxide (Y₂O₃) hollow microspheres. The aforementioned compositions may further comprise a binder (e.g., an inorganic binder). The present invention features a solar reflectivity composition comprising metal oxide (e.g., Y₂O₃) hollow microspheres and an inorganic binder (e.g., KBr). In some embodiments, the hollow microspheres and the inorganic binder are in a solution (e.g., water). Additionally, the solution comprising the hollow microspheres and the inorganic binder may be deposited onto a substrate (e.g., a black substrate). The compositions described herein may have a thickness of about 0.2 mm to 2.5 mm, or about 0.2 mm to 1.5 mm, or about 0.2 mm to 0.5 mm, or about 0.5 mm to 2.5 mm, or about 0.5 mm to 1.5 mm, or about 1.5 mm to 2.5 mm. Furthermore, the solar reflectivity of the composition may be about 0.90 to 0.98.

In some embodiments, the present invention features a method of producing a high solar reflectivity coating comprising metal oxide hollow microspheres. The method may comprise (a) dissolving an inorganic binder (e.g., KBr) in a solution, (b) dispersing the hollow microspheres into the solution, and (c) depositing the solution comprising the hollow microspheres and inorganic binder (e.g., KBr) to a substrate to obtain the high solar reflectivity coating.

In other embodiments, the present invention features a method of producing metal oxide hollow microspheres. The method may comprise (a) synthesizing carbonaceous microspheres, (b) forming precursor shells on the carbonaceous microspheres, and (c) calcinating the precursor shells to remove the carbonaceous microspheres and decomposing the precursor shells to obtain a metal oxide (e.g., Y₂O₃) hollow microsphere.

One of the unique and inventive technical features of the present invention is the coating based on Y₂O₃ hollow microspheres and KBr binder. Without wishing to limit the invention to any theory or mechanism, it is believed that the technical feature of the present invention advantageously provides for higher solar reflectivity compared to previously reported values in publications. None of the presently known prior references or work has the unique inventive technical feature of the present invention.

Furthermore, the prior references teach away from the present invention. For example, current commercial white paint solutions use TiO₂ microspheres or nanoparticles. Contrarily, the present invention uses Y₂O₃ hollow microspheres to achieve high solar reflectivity. Both the use of Y₂O₃ material and hollow microspheres are critical to achieving high solar reflectivity. Y₂O₃ is intrinsically transparent and provides a refractive index of around 1.9 in the solar wavelength range. Additionally, hollow microspheres are more efficient in scattering the sunlight due to the Mie scattering effect compared to solid microspheres.

Furthermore, the prior references also teach away from the present invention in that organic or polymer binders are used. Contrarily, the present invention uses an inorganic KBr binder, which is important for achieving high solar reflectivity. Compared to organic binders, KBr shows less absorption in the near-infrared wavelength range, thus leading to higher solar reflectivity. Therefore, other white coatings, including commercial paints that rely on organic binders may experience significant absorption in the near-infrared wavelength range and have a lower solar reflectivity.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of the fabrication process of Y₂O₃ hollow microspheres. The process involves (1) the formation of carbon spheres using hydrothermal treatment; (2) coating of the carbon microsphere cores with YCl₃ precursors using ultrasonication and subsequent urea-based precipitation at elevated temperatures; and (3) removal of carbon cores via calcination at high temperatures in the tube furnace.

FIGS. 2A, 2B, 2C, 2D, 2E, and 2F shows the characterization of Y₂O₃ hollow microspheres. FIG. 2A shows a top-view SEM image of carbon microspheres after a hydrothermal reaction at 180° C. for 8 hours. Scale bar: 20 μm; FIGS. 2B and 2C show Y₂O₃ hollow microspheres after calcination at 800° C. for 6 hours. Scale bar: 10 μm; FIG. 2D shows EDS analysis on Y₂O₃ hollow microspheres showing the presence of Y and O elements; FIG. 2E shows a zoom-in SEM image of Y₂O₃ hollow microspheres and FIG. 2F shows the corresponding EDS mapping of C, O, Y, and Cl elements. Scale bar: 10 μm.

FIG. 3 shows a schematic of the fabrication process of white coatings based on Y₂O₃ hollow microspheres and KBr binder. KBr particles are first dissolved in DI water, and then Y₂O₃ hollow microspheres are dispersed into the solution. After ultrasonication for 10 mins, the mixed solution is drop-casted onto black substrates to make the white coating materials.

FIGS. 4A, 4B, and 4C shows UV-VIS-NIR reflectivity of Y₂O₃ hollow microspheres based white coatings. FIG. 4A shows an absolute UV-VIS-NIR reflectivity of 0.48-mm-thick and 0.92-mm-thick white coating based on Y₂O₃ hollow microspheres on glass slide substrates; FIG. 4B shows a weighted solar reflectivity as a function of thickness in Y₂O₃ hollow-microspheres-based white coatings and reflectivity predictions based on the diffusion theory with transport mean free path calculations for a thickness of 0-2 mm; FIG. 4C shows the zoom-in reflectivity in the visible wavelength region (0.4-0.8 μm) of 0.48-mm-thick and 0.92-mm-thick white coating based on Y₂O₃ hollow microspheres on glass slide substrates. The weighted solar reflectivity R_{weighted} is calculated using equation (5.1) below.

### DETAILED DESCRIPTION OF THE INVENTION

Before the present compounds, compositions, and/or methods are disclosed and described, it is to be understood that this invention is not limited to specific synthetic methods or to specific compositions, as such may, of course, vary. It is also to be understood that the terminology used herein is for the purpose of describing particular embodiments only and is not intended to be limiting.

Additionally, although embodiments of the disclosure have been described in detail, certain variations and modifications will be apparent to those skilled in the art, including embodiments that do not provide all the features and benefits described herein. It will be understood by those skilled in the art that the present disclosure extends beyond the specifically disclosed embodiments to other alternative or additional embodiments and/or uses and obvious modifications and equivalents thereof. Moreover, while a number of variations have been shown and described in varying detail, other modifications, which are within the scope of the present disclosure, will be readily apparent to those of skill in the art based upon this disclosure. It is also contemplated that various combinations or sub-combinations of the specific features and aspects of the embodiments may be made and still fall within the scope of the present disclosure. Accordingly, it should be understood that various features and aspects of the disclosed embodiments can be combined with or substituted for one another in order to form varying modes of the present disclosure. Thus, it is intended that the scope of the present disclosure herein disclosed should not be limited by the particular disclosed embodiments described herein.

As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

As used herein, the term “solar reflectivity” refers to a fraction of the incident solar energy that is reflected by a surface in the solar region whose wavelength range is around 0.2-2.5 μm. Solar reflectivity ranges from 0 to 1, where a solar reflectivity of 0 indicates a material absorbs all solar energy, and a value of 1 indicates total reflectance. A high value for solar reflectivity is considered to be from about 0.8 to 1.

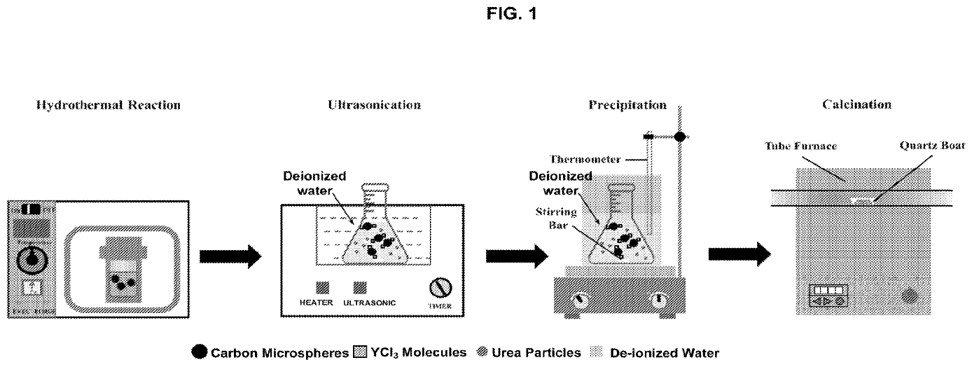

Referring now to FIGS. 1-4B, the present invention features compositions comprising a white coating based on yttrium oxide (Y₂O₃) hollow microspheres for high solar reflectivity and passive solar reflection or radiative cooling applications, as well as methods for production thereof.

The present invention features a high solar reflectivity composition comprising metal oxide hollow microspheres. In some embodiments, the present invention features a high solar reflectivity composition comprising yttrium oxide (Y₂O₃) hollow microspheres. In some embodiments, a “high” solar reflectivity may refer to a solar reflectivity greater than 0.90. In other embodiments, a “high” solar reflectivity may refer to a solar reflectivity greater than 0.95.

The present invention may also feature a high solar reflectivity coating composition comprising metal oxide (e.g., yttrium oxide (Y₂O₃)) hollow microspheres. For example, the present invention features a high solar reflectivity coating comprising yttrium oxide (Y₂O₃) hollow microspheres.

The aforementioned compositions may further comprise a binder, e.g., an inorganic binder. In some embodiments, the inorganic binder comprises potassium bromide (KBr). In other embodiments, the inorganic binder comprises potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof.

The present invention may feature a solar reflectivity composition comprising metal oxide (e.g., yttrium oxide (Y₂O₃)) hollow microspheres, and an inorganic binder. Alternatively, the present invention may feature a high solar reflectivity coating composition comprising metal oxide (e.g., yttrium oxide (Y₂O₃)) hollow microspheres and an inorganic binder.

The compositions may further comprise a solution. For example, the hollow microspheres and/or binder may be in a solution. In some embodiments, the solution is water. In other embodiments, the solution is deionized water.

The present invention may feature a solar reflectivity composition comprising metal oxide (e.g., yttrium oxide (Y₂O₃)) hollow microspheres and an inorganic binder in a solution. Likewise, the present invention may feature a high solar reflectivity coating composition comprising metal oxide hollow (e.g., yttrium oxide (Y₂O₃)) microspheres and an inorganic binder in a solution.

In some embodiments, the solution comprising the hollow microspheres and the binder (e.g., the inorganic binder) may be disposed on a substrate. In some embodiments, the substrate comprises a black substrate. In other embodiments, the substrate comprises a wood, concrete, or glass slide.

As such, the present invention features a solar reflectivity composition comprising metal oxide (e.g., yttrium oxide (Y₂O₃)) hollow microspheres and an inorganic binder in a solution, wherein the solution comprising the hollow microspheres and the inorganic binder is disposed on a substrate. Likewise, the present invention features a high solar reflectivity coating composition comprising metal oxide (e.g., yttrium oxide (Y₂O₃)) hollow microspheres and an inorganic binder in a solution, wherein the solution comprising the hollow microspheres and the inorganic binder is disposed on a substrate.

In some embodiments, the compositions (e.g., the coating) described herein have a thickness of about In other embodiments, the compositions described herein have a thickness of about 0.2 to 2.5 mm or about 0.2 to 2.25 mm, or about 0.2 to 2.0 mm, or about 0.2 to 1.75 mm, or about 0.2 to 1.5 mm, or about 0.2 to 1.25 mm, or about 0.2 to 1.0, or about 0.2 to 0.75 mm, or about 0.2 to 0.5 mm, or about 0.2 to 0.4 mm, or about 0.2 to 0.3 mm, or about 0.3 to 2.5 mm or about 0.3 to 2.25 mm, or about 0.3 to 2.0 mm, or about 0.3 to 1.75 mm, or about 0.3 to 1.5 mm, or about 0.3 to 1.25 mm, or about 0.3 to 1.0, or about 0.3 to 0.75 mm, or about 0.3 to 0.5 mm, or about 0.3 to 0.4 mm, or about 0.4 to 2.5 mm or about 0.4 to 2.25 mm, or about 0.4 to 2.0 mm, or about 0.4 to 1.75 mm, or about 0.4 to 1.5 mm, or about 0.4 to 1.25 mm, or about 0.4 to 1.0, or about 0.4 to 0.75 mm, or about 0.4 to 0.5 mm, or about 0.5 to 2.5 mm or about 0.5 to 2.25 mm, or about 0.5 to 2.0 mm, or about 0.5 to 1.75 mm, or about 0.5 to 1.5 mm, or about 0.5 to 1.25 mm, or about 0.5 to 1.0, or about 0.5 to 0.75 mm, or about 0.75 to 2.5 mm or about 0.75 to 2.25 mm, or about 0.75 to 2.0 mm, or about 0.75 to 1.75 mm, or about 0.75 to 1.5 mm, or about 0.75 to 1.25 mm, or about 0.75 to 1.0, or about 1.0 to 2.5 mm or about 1.0 to 2.25 mm, or about 1.0 to 2.0 mm, or about 1.0 to 1.75 mm, or about 1.0 to 1.5 mm, or about 1.0 to 1.25 mm, or about 1.25 to 2.5 mm or about 1.25 to 2.25 mm, or about 1.25 to 2.0 mm, or about 1.25 to 1.75 mm, or about 1.25 to 1.5 mm, or about 1.50 to 2.5 mm or about 1.50 to 2.25 mm, or about 1.50 to 2.0 mm, or about 1.50 to 1.75 mm, or about 1.75 to 2.5 mm or about 1.75 to 2.25 mm, or about 1.75 to 2.0 mm, or about 2.0 to 2.5 mm or about 2.0 to 2.25 mm, or about 2.25 to 2.5 mm.

In some embodiments, the compositions described herein have a solar reflectivity of about 0.95. In some embodiments, the compositions described herein have a solar reflectivity of about 0.98. In some embodiments, the compositions described herein have a solar reflectivity of about 0.90 to 0.98. In other embodiments, the compositions described herein have an absolute solar reflectivity of about 0.99 to 0.98, or about 0.99 to 0.96, or about 0.99 to 0.94, or about 0.99 to 0.92, or about 0.99 to 0.90, or about 0.99 to 0.88, or about 0.98 to 0.96, or about 0.98 to 0.94, or about 0.98 to 0.92, or about 0.98 to 0.90, or about 0.98 to 0.88, or about 0.96 to 0.94, or about 0.96 to 0.92, or about 0.96 to 0.90, or about 0.96 to 0.88, or about 0.94 to 0.92, or about 0.94 to 0.90, or about 0.94 to 0.88, or about 0.92 to 0.90, or about 0.92 to 0.88, or about 0.90 to 0.88. In some embodiments, the compositions described herein have a solar reflectivity of about 0.95 to 0.98.

In some embodiments, the compositions described herein have a visible reflectivity (e.g., reflectivity in the visible wavelength region (e.g., wavelengths of about 0.4-0.8 μm) of about 0.99 to 0.98, or about 0.99 to 0.96, or about 0.99 to 0.94, or about 0.99 to 0.92, or about 0.99 to 0.90, or about 0.99 to 0.88, or about 0.98 to 0.96, or about 0.98 to 0.94, or about 0.98 to 0.92, or about 0.98 to 0.90, or about 0.98 to 0.88, or about 0.96 to 0.94, or about 0.96 to 0.92, or about 0.96 to 0.90, or about 0.96 to 0.88, or about 0.94 to 0.92, or about 0.94 to 0.90, or about 0.94 to 0.88, or about 0.92 to 0.90, or about 0.92 to 0.88, or about 0.90 to 0.88. In some embodiments, the compositions described herein have a visible reflectivity of about 0.95 to 0.98.

The present invention may also feature a method of producing a high solar reflectivity coating comprising metal oxide hollow microspheres. The method may comprise (a) dissolving an inorganic binder (e.g., potassium bromide (KBr)) in a solution, (b) dispersing the hollow microspheres into the solution, and (c) depositing the solution comprising the hollow microspheres and the inorganic binder onto a substrate to obtain the high solar reflectivity coating.

In some embodiments, the metal oxide comprises yttrium oxide (Y₂O₃). Thus, the present invention features a method of producing a high solar reflectivity coating comprising yttrium oxide (Y₂O₃) hollow microspheres. The method may comprise (a) dissolving an inorganic binder (e.g., potassium bromide (KBr)) in a solution, (b) dispersing the hollow microspheres into the solution, and (c) depositing the solution comprising the hollow microspheres and the inorganic binder onto a substrate to obtain the high solar reflectivity coating.

Non-limiting examples of inorganic binders that may be used in accordance with the methods described herein may include but are not limited to potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof.

In some embodiments, the solution comprises water. In other embodiments, the solution comprises deionized water.

In some embodiments, the hollow microspheres are dispersed into the solution using ultrasonication. In some embodiments, depositing the solution onto a substrate comprises drop-casting the solution onto the substrate (e.g., a black substrate).

In some embodiments, the solution is heated to about 90° C. In other embodiments, the solution is heated to about 100° C., or about 95° C., or about 90° C., or about 85° C., or about 80° C.

The methods described herein produce a high solar reflectivity coating comprising metal oxide hollow microspheres (e.g., Y₂O₃ hollow microspheres).

The present invention may also feature a method of producing metal oxide (e.g., Y₂O₃) hollow microspheres. The method may comprise (a) synthesizing carbonaceous microspheres, (b) forming a precursor shell on the carbonaceous microspheres, and (c) calcinating the precursor shells to remove the carbonaceous microspheres and decomposing the precursor shells to obtain a metal oxide (e.g., Y₂O₃) hollow microsphere.

In some embodiments, the carbonaceous microspheres are synthesized by hydrothermal carbonization of glucose. In some embodiments, the precursor shell is formed by a homogeneous precipitation method using a precipitation agent (e.g., urea).

In some embodiments, the precursor shell is calcinated in air. In some embodiments, the metal oxide comprises yttrium oxide (Y₂O₃).

The method described herein may produce a high solar reflectivity composition comprising metal oxide hollow microspheres (e.g., Y₂O₃ hollow microspheres).

### EXAMPLE

The following is a non-limiting example of the present invention. It is to be understood that said example is not intended to limit the present invention in any way. Equivalents or substitutes are within the scope of the present invention.

Preparation of Y₂O₃ Hollow Microspheres:

Templated hydrothermal reactions are generally used for hollow microspheres fabrication due to their safe and easy operations. Similar hydrothermal treatment was used to fabricate Y₂O₃ hollow microspheres. The fabrication process is composed of three steps in the following:
1. The synthesis of carbon microspheres template by hydrothermal carbonization of glucose.
2. Formation of a precursor with core-shell structure by a homogeneous precipitation method using urea as the precipitation agent (90° C.).
3. Calcination of the precursor in air to remove the carbon cores and make the precursor shell decompose completely, thus resulting in Y₂O₃ hollow microspheres

A schematic illustration for the overall formation process of the Y₂O₃ hollow microspheres is presented in FIG. 1. In the second step, urea serves as a precipitating agent and plays an important role in the formation of precursor shells onto the surfaces of carbonaceous microspheres. The decomposition of urea releases precipitating anions (mainly OH⁻ and

$${CO}_{3}^{2 -} )$$

slowly into the solution at the elevated temperature and results in the homogeneous precipitation of the precursor nanoparticles coated on the carbon microsphere surface. In the calcination step, carbon microsphere cores are burned out and the shell of precursor nanoparticles is transformed into a crystalline oxide hollow microspheres.

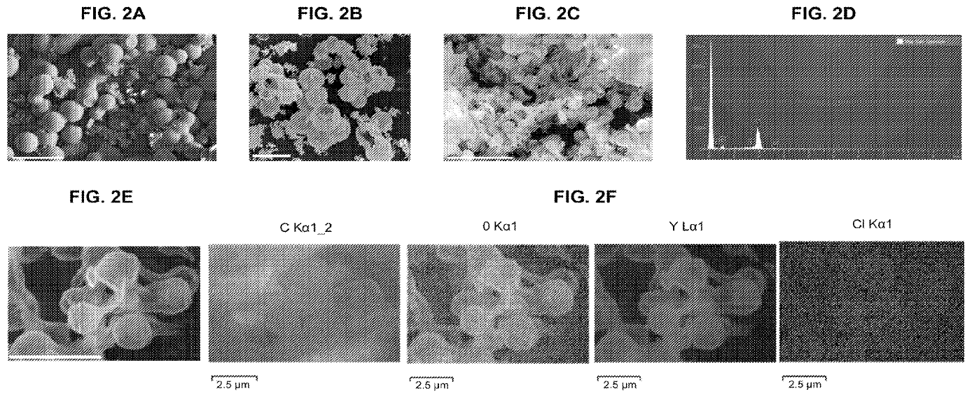

FIG. 2A shows the top-view scanning electron microscope (SEM) image of carbonaceous microspheres. The SEM image indicates carbonaceous microspheres have a diameter range of around 8-10 μm. FIG. 2B and FIG. 2C shows the SEM images of Y₂O₃ hollow microspheres after 800° C. calcination for 6 hours in a tube furnace. Images show that hollow microspheres exhibit a diameter of around 5-8 μm, shrinking when the carbon cores are burned out during the calcination process. The hollow structures are also significant in the SEM images and the shell thickness is measured to be around 100-200 nm. FIG. 2D is the energy dispersive (EDS) analysis of hollow microspheres showing that Y and O elements are the main elements in them, while the C element is also shown because of the carbon tape beneath the microspheres. An EDS mapping was also performed on the SEM image, as shown in FIG. 2E, and the results are presented in FIG. 2F. It is clear that Y and O elements are only abundant in hollow microspheres, while C and Cl in the precursors are not apparent in microspheres. The SEM and EDS characterizations indicate the successful fabrication of Y₂O₃ hollow microspheres.

Preparation of Y₂O₃-Based White Coatings:

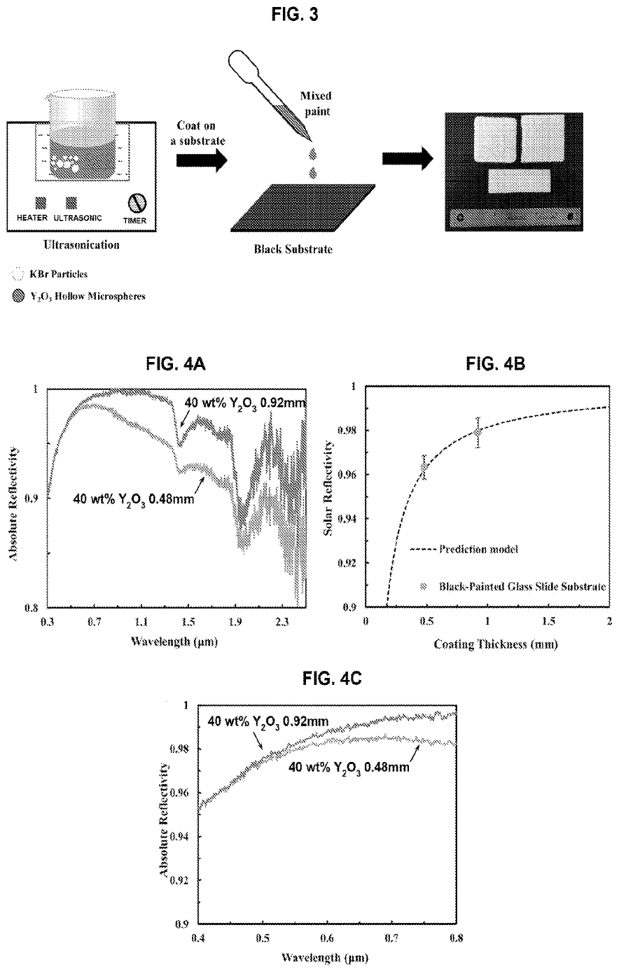

The successful fabrication of Y₂O₃ hollow microspheres makes white coating fabrication possible. Potassium bromide (KBr) binder was used to integrate hollow microspheres together due to its solar transmittance in the whole solar region. The previous measurements on spray coatings based on hollow glass microspheres show that KBr is almost 100% transparent in the entire solar region. FIG. 3 is a simple schematic showing the white coating fabrication process. After ultrasonication of mixed hollow microspheres and KBr in the DI water, the solution is drop-casted onto any substrates such as wood, concrete or glass slides with various shapes and dimensions. The weight ratio of hollow microspheres is controlled at 40% so that they can be fully integrated by KBr binder.

Optical Properties and Thermal Analysis of Y₂O₃-Based White Coatings:

The previous numerical simulation results indicate that Y₂O₃ hollow microspheres could lead to ultrahigh reflectivity in the solar region, and optical measurements were performed of white coatings after fabrications. The solar reflectivity of white coatings are measured using Ultraviolet-Visible-Near Infrared (UV-VIS-NIR) spectroscopic measurements in the wavelength region of 0.3-2.5 μm. The measured results show that white coatings based on Y₂O₃ hollow microspheres exhibit ultrahigh reflectivity across the UV, visible, and near infrared region. Thus, weighted solar reflectivity was calculated using equation (5.1) below in the wavelength region of 0.3-2.4 μm. The weighted solar reflectivity of the 0.48-mm-thick white coating reaches 0.9632, while it increases to 0.9789 with a thickness of 0.92 mm (FIG. 4A).

$${R}_{weighted} = \frac{{\int }_{0.3}^{2.5} R ( λ ) {I}_{AM 1 \text{.5}} ( λ ) d λ}{{\int }_{0.3}^{2.5} {I}_{AM 1 \text{.5}} ( λ ) d λ} \# \qquad ( 5.1 )$$

A clear thickness-dependence is observed from various samples with different thicknesses. The diffusion theory can be used to develop the thickness-dependence predictions of hollow-microspheres-based-composites, and it can be applied to spray coating samples after the input has been changed to the refractive index of KBr in the solar region. The diffusion theory relates transmissivity of the composite system (T) to its thickness (L) by following equation:

$$T = \frac{{l}^{*} ( 1 + s )}{L + 2 {l}^{*} s} \# \qquad ( 5.2 )$$

In equation (5.2), s is the extrapolation length ratio that can be calculated using s=2(1+R)/[3(1−R)], where R is the internal reflectance. The VAT model is used to estimate the value of s by using the refractive index of Y₂O₃ (n=1.9) and KBr (n=1.56). The spectral reflectivity (Rₛ) is calculated using Rₛ=1−T.

FIG. 4B indicates the thickness dependence on solar reflectivity of white coatings from a thickness of 20 μm (or 0.02 mm) to 2000 μm (or 2 mm) using the diffusion theory, which shows the agreement with measured weighted solar reflectivity values.

To sum up, Y₂O₃ hollow microspheres were synthesized using carbon microspheres templated hydrothermal approaches. The approach involves the formation of carbonaceous microspheres using hydrothermal reaction, the homogeneous precipitation of precursor materials on the surface of carbonaceous microspheres with the assistance of urea, and the removal of carbon cores with high temperature calcination. White coatings based on Y₂O₃ hollow microspheres have been fabricated on various substrates using a common casting method. The reflectivity measurements indicate that Y₂O₃ hollow microspheres lead to ultrahigh solar reflectivity of 0.9789 with a thickness of 0.92 mm. Solar reflectivity of white coatings presents a strong relationship with their thicknesses, which can be predicted using the diffusion theory. This work demonstrates the ultrahigh solar reflectivity and provides promising solutions for near-perfect solar reflectors with scalable and easy fabrications.

Synthesis of Y₂O₃ Hollow Microspheres:

Preparation of Carbonaceous Microspheres. In a typical preparation, 28 g of glucose is dissolved in 240 mL of DI water to form a clear solution. The solution is then sealed in a 500 mL PTFE-lined stainless steel autoclave and maintained at 180° C. for 8 hours. After naturally cooling the autoclave to room temperature, the resulting solution is washed with DI water several times and then dried at 100° C. in the oven for 12 hours.

Synthesis of Y₂O₃ Hollow Microspheres. 1.6 g of YCl₃ precursor is dissolved in 150 mL DI water to form a clear solution. 8 g of urea and 5 g of carbonaceous microsphere from the last procedure is added to the solution. The solution is ultrasonicated for 20 minutes and then transferred to a water bath at 90° C. for 3 hours with vigorous stirring. Then the resulting solution is vacuum filtered and the precursors are washed by DI water several times before being dried in the oven. The final hollow microspheres are obtained by calcination in the tube furnace at 800° C. for 6 hours with a heating rate of 2° C./min.

### Optical Spectroscopy:

The optical properties in the visible and NIR region are characterized by Ultraviolet-Visible-NIR (UV-VIS-NIR) spectrometer (Jasco V670 coupled with a 60 mm integrating sphere, Jasco Technology) in the wavelength range from 0.3 μm to 2.5 μm. The diffuse reflectivity measurements are calibrated with a standard white Spectralon standard. The optical properties in the mid-IR region are characterized by Fourier-transform infrared (FTIR) spectrometers (Nicolet 6700, Thermo Scientific) with an integrating sphere (Mid-IR IntegratlR™ Pike Technologies). The emissivity is calculated based on the sum of the transmissivity, reflectivity and absorptivity being unity and Kirchhoff's Law assuming that emissivity is considered equal to absorptivity. The optical measurements have an inherent uncertainty of +0.003 for the properties ranging from 0 to 1 and the wavelength uncertainty of the spectrometers is ±0.3 nm at a standard room temperature of 25° C.

### Scanning Electron Microscopy:

Scanning electron microscopy images of Y₂O₃ hollow microspheres are taken using a Magellan 400 scanning electron microscope (SEM). The composition of the samples are inspected using the Magellan 400 SEM equipped with an energy-dispersive X-ray spectrum and mapping.

### Embodiments

The following embodiments are intended to be illustrative only and not to be limiting in any way.

Embodiment 1: A solar reflectivity composition comprising metal oxide hollow microspheres. Embodiment 2: The composition of embodiment 1, wherein the metal oxide comprises yttrium oxide (Y₂O₃). Embodiment 3: A solar reflectivity composition comprising yttrium oxide (Y₂O₃) hollow microspheres. Embodiment 4: The composition of any one of embodiments 1-3 further comprising a binder. Embodiment 5: The composition of any one of embodiments 1-4, wherein the binder is an inorganic binder.

Embodiment 6: A solar reflectivity composition comprising metal oxide hollow microspheres and an inorganic binder. Embodiment 7: A solar reflectivity composition comprising yttrium oxide (Y₂O₃) hollow microspheres and an inorganic binder. Embodiment 8: The composition of any one of embodiments 1-7, wherein the inorganic binder comprises potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof. Embodiment 9: The composition of any one of embodiments 1-6, wherein the hollow microspheres and/or binder are in a solution.

Embodiment 10: A solar reflectivity composition comprising metal oxide hollow microspheres and an inorganic binder in a solution. Embodiment 11: A solar reflectivity composition comprising yttrium oxide (Y₂O₃) hollow microspheres and an inorganic binder in a solution. Embodiment 12: The composition of any one of embodiments 1-11, wherein the solution is water (e.g., deionized water). Embodiment 13: The composition of any one of embodiments 1-12 further comprising a substrate.

Embodiment 14: A solar reflectivity composition comprising metal oxide hollow microspheres and an inorganic binder in a solution disposed on a substrate. Embodiment 15: A solar reflectivity composition comprising yttrium oxide (Y₂O₃) hollow microspheres and an inorganic binder in a solution disposed on a substrate. Embodiment 16: The composition of any one of embodiments 1-15, wherein the substrate comprises wood, concrete, or a glass slide.

Embodiment 17: The composition of any one of embodiments 1-16, wherein the composition comprises a thickness of about 0.2 to 2.5 mm.

Embodiment 18: The composition of any one of embodiments 1-16, wherein the composition comprises a thickness of about 0.2 to 1.5 mm.

Embodiment 19: The composition of any one of embodiments 1-16, wherein the composition comprises a thickness of about 0.2 to 0.5 mm. Embodiment 20: The composition of any one of embodiments 1-16, wherein the composition comprises a thickness of about 0.5 to 2.5 mm. Embodiment 21: The composition of any one of embodiments 1-16, wherein the composition comprises a thickness of about 0.5 to 1.5 mm. Embodiment 22: The composition of any one of embodiments 1-16, wherein the composition comprises a thickness of about 1.50 to 2.5 mm.

Embodiment 23: The composition of any one of embodiments 1-22, wherein the composition comprises a solar reflectivity of about 0.88 to 0.98. Embodiment 24: The composition of any one of embodiments 1-22, wherein the composition comprises a solar reflectivity of about 0.90 to 0.98. Embodiment 25: The composition of any one of embodiments 1-22, wherein the composition comprises a solar reflectivity of about 0.95 to 0.98.

Embodiment 26: A high solar reflectivity coating composition comprising metal oxide hollow microspheres. Embodiment 27: The coating of embodiment 26, wherein the metal oxide comprises yttrium oxide (Y₂O₃). Embodiment 28: A high solar reflectivity coating comprising yttrium oxide (Y₂O₃) hollow microspheres. Embodiment 29: The composition of any one of embodiments 26-28 further comprising a binder. Embodiment 30: The composition of any one of embodiments 26-29, wherein the binder is an inorganic binder.

Embodiment 31: A high solar reflectivity coating composition comprising metal oxide hollow microspheres and an inorganic binder. Embodiment 32: A high solar reflectivity coating composition comprising yttrium oxide (Y₂O₃) hollow microspheres and an inorganic binder. Embodiment 33: The composition of any one of embodiments 26-32, wherein the inorganic binder comprises potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof. Embodiment 34: The composition of any one of embodiments 26-33, wherein the hollow microspheres and/or binder are in a solution.

Embodiment 35: A high solar reflectivity coating composition comprising metal oxide hollow microspheres and an inorganic binder in a solution. Embodiment 36: A high solar reflectivity coating composition comprising yttrium oxide (Y₂O₃) hollow microspheres and an inorganic binder in a solution. Embodiment 37: The composition of any one of embodiments 26-36, wherein the solution is water. Embodiment 38: The composition of any one of embodiments 26-37 further comprising a substrate.

Embodiment 39: A high solar reflectivity coating composition comprising metal oxide hollow microspheres and an inorganic binder in a solution disposed on a substrate. Embodiment 40: A high solar reflectivity coating composition comprising yttrium oxide (Y₂O₃) hollow microspheres and an inorganic binder in a solution disposed on a substrate. Embodiment 41: The composition of any one of embodiments 26-40, wherein the substrate comprises wood, concrete, or a glass slide.

Embodiment 42: The composition of any one of embodiments 26-40, wherein the composition comprises a thickness of about 0.2 to 2.5 mm. Embodiment 43: The composition of any one of embodiments 26-40, wherein the composition comprises a thickness of about 0.2 to 1.5 mm. Embodiment 44: The composition of any one of embodiments 26-40, wherein the composition comprises a thickness of about 0.2 to 0.5 mm. Embodiment 45: The composition of any one of embodiments 26-40, wherein the composition comprises a thickness of about 0.5 to 2.5 mm. Embodiment 46: The composition of any one of embodiments 26-40, wherein the composition comprises a thickness of about 0.5 to 1.5 mm. Embodiment 47: The composition of any one of embodiments 26-40, wherein the composition comprises a thickness of about 1.50 to 2.5 mm.

Embodiment 48: The composition of any one of embodiments 26-47, wherein the composition comprises a solar reflectivity of about 0.88 to 0.98. Embodiment 49: The composition of any one of embodiments 26-47, wherein the composition comprises a solar reflectivity of about 0.90 to 0.98. Embodiment 50: The composition of any one of embodiments 26-47, wherein the composition comprises a solar reflectivity of about 0.95 to 0.98.

Embodiment 51: A method of producing a high solar reflectivity coating comprising metal oxide hollow microspheres according to any one of embodiments 26-50, the method comprising a) dissolving an inorganic binder in a solution, b) dispersing the hollow microspheres into the solution, and c) depositing the solution comprising the hollow microspheres and the inorganic binder onto a substrate to obtain the high solar reflectivity coating.

Embodiment 52: The method of embodiment 51, wherein the inorganic binder comprises potassium bromide (KBr). Embodiment 53: The method of embodiment 51, wherein the inorganic binder comprises potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof.

Embodiment 54: The method of any one of embodiments 51-53, wherein the solution comprises water. Embodiment 55: The method of any one of embodiments 51-53, wherein the solution comprises deionized water.

Embodiment 56: The method of any one of embodiments 51-55, wherein the hollow microspheres are dispersed into the solution using ultrasonication. Embodiment 57: The method of any one of embodiments 51-56, wherein depositing the solution onto the substrate comprises drop-casting the solution onto the substrate.

Embodiment 58: The method of any one of embodiments 51-57, wherein the substrate comprises a black substrate. Embodiment 59: The method of any one of embodiments 51-57, wherein the substrate comprises wood, concrete, or a glass slide. Embodiment 60: The method of any one of embodiments 51-57, wherein the metal oxide comprises yttrium oxide (Y₂O₃).

Embodiment 61: A method of producing a high solar reflectivity coating comprising metal oxide hollow microspheres, the method comprising: a) dissolving an inorganic binder in a solution, b) dispersing the hollow microspheres into the solution, and c) depositing the solution comprising the hollow microspheres and the inorganic onto a substrate to obtain the high solar reflectivity coating. Embodiment 62: The method of embodiment 61, wherein the metal oxide comprises yttrium oxide (Y₂O₃). Embodiment 63: A method of producing a high solar reflectivity coating comprising yttrium oxide (Y₂O₃) hollow microspheres, the method comprising: a) dissolving an inorganic binder in a solution, b) dispersing the hollow microspheres into the solution and c) depositing the solution comprising the hollow microspheres and the inorganic onto a substrate to obtain the high solar reflectivity coating.

Embodiment 64: The method of any one of embodiments 61-63, wherein the inorganic binder comprises potassium bromide (KBr), potassium chloride (KCl), cesium bromide (CsBr), barium fluoride (BaF2), calcium fluoride (CaF2), magnesium fluoride (MgF2), strontium fluoride (SrF2), sodium chloride (NaCl), or sodium fluoride (NaF) or a combination thereof.

Embodiment 65: A method of producing a high solar reflectivity coating comprising metal oxide hollow microspheres, the method comprising a) dissolving potassium bromide (KBr) in a solution, b) dispersing the hollow microspheres into the solution, and c) depositing the solution comprising the hollow microspheres and KBr onto a substrate to obtain the high solar reflectivity coating. Embodiment 66: A method of producing a high solar reflectivity coating comprising yttrium oxide (Y₂O₃) hollow microspheres, the method comprising: a) dissolving potassium bromide (KBr) in a solution, b) dispersing the hollow microspheres into the solution, and c) depositing the solution comprising the hollow microspheres and KBr onto a substrate to obtain the high solar reflectivity coating.

Embodiment 67: The method of any one of embodiments 61-66, wherein the solution comprises water. Embodiment 68: The method of any one of embodiments 61-66, wherein the solution comprises deionized water.

Embodiment 69: The method of any one of embodiments 61-68, wherein the hollow microspheres are dispersed into the solution using ultrasonication.

Embodiment 70: The method of any one of embodiments 61-69, wherein the depositing the solution onto a substrate comprises drop-casting the solution onto the substrate. Embodiment 71: The method of any one of embodiments 61-70, wherein the substrate comprises a black substrate. Embodiment 72: The method of any one of embodiments 61-70, wherein the substrate comprises wood, concrete, or a glass slide.

Embodiment 73: The method of any one of embodiments 61-72, wherein the method produces a high solar reflectivity coating comprising hollow microspheres.

Embodiment 74: A method of producing metal oxide hollow microspheres, the method comprising: a) synthesizing carbonaceous microspheres, b) forming a precursor shell on the carbonaceous microspheres, wherein the precursor shell comprises a metal compound, and c) calcinating the precursor shells to remove the carbonaceous microspheres and decomposing the precursor shells to obtain a metal oxide hollow microsphere.

Embodiment 75: The method of embodiment 74, wherein the carbonaceous microspheres are synthesized by hydrothermal carbonization of glucose. Embodiment 76: The method of embodiment 74 or 75, wherein the precursor shell is formed by a homogeneous precipitation method using a precipitation agent. Embodiment 77: The method of any one of embodiments 74-76, wherein the precipitation agent is urea. Embodiment 78: The method of any one of embodiments 74-77, wherein the precursor shell is calcinated in air. Embodiment 79: The method of any one of embodiments 74-77, wherein the precursor shell is calcinated in an inert gas. Embodiment 80: The method of any one of embodiments 74-79, wherein the metal oxide comprises yttrium oxide (Y₂O₃).

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1.-10. (canceled)

11. A high solar reflectivity coating composition comprising yttrium oxide (Y₂O₃) hollow microspheres and an inorganic binder in a solution, wherein the inorganic binder comprises potassium bromide (KBr).

12. The composition of claim 11, wherein the solution is water or deionized water.

13. The composition of claim 11, wherein the solution comprising the Y₂O₃ hollow microspheres and the inorganic binder is disposed on a substrate.

14.-15. (canceled)

16. The composition of claim 13, wherein the substrate comprises wood, concrete, or a glass slide.

17.-19. (canceled)

20. The composition of claim 11, wherein the composition comprises a solar reflectivity of about 0.90 to 0.98.

21. A method of producing the high solar reflectivity coating composition according to claim 11, the method comprising
a) dissolving the inorganic binder in the solution; and
b) dispersing the yttrium oxide (Y₂O₃) hollow microspheres into the solution to obtain the high solar reflectivity coating.

22. The method of claim 21 further comprises depositing the solution comprising the hollow microspheres and the inorganic binder onto a substrate.

23. (canceled)

24. The method of claim 21, wherein the solution comprises water or deionized water.

25. (canceled)

26. The method of claim 21, wherein the Y₂O₃ hollow microspheres are dispersed into the solution using ultrasonication.

27. The method of claim 22, wherein depositing the solution onto the substrate comprises drop-casting the solution onto the substrate.

28. The method of claim 27, wherein the substrate comprises a black substrate.

29. The method of claim 27, wherein the substrate comprises wood, concrete, or a glass slide.

30.-43. (canceled)

44. A method of producing metal oxide hollow microspheres, the method comprising:
a) synthesizing carbonaceous microspheres,
b) forming a precursor shell on the carbonaceous microspheres, wherein the precursor shell comprises a metal compound, and
c) calcinating the precursor shells to remove the carbonaceous microspheres and decomposing the precursor shells to obtain a metal oxide hollow microsphere.

45. The method of claim 44, wherein the carbonaceous microspheres are synthesized by hydrothermal carbonization of glucose.

46. The method of claim 44, wherein the precursor shell is formed by a homogeneous precipitation method using a precipitation agent.

47. The method of claim 46, wherein the precipitation agent is urea.

48. The method of claim 44, wherein the precursor shell is calcinated in air.

49. The method of claim 44, wherein the precursor shell is calcinated in an inert gas.

50. The method of claim 44, wherein the metal oxide comprises yttrium oxide (Y₂O₃).
